(19) United States
(12) Patent Application Publication
(10) Pub. No.: US 2014/0375321 A1
(43) Pub. Date: Dec. 25, 2014

(54) SENSOR DEVICE

(71) Applicant: AISAN KOGYO KABUSHIKI KAISHA, Obu-shi (JP)

(72) Inventor: Masaki Ikeya, Obu-shi (JP)

(73) Assignee: AISAN KOGYO KABUSHIKI KAISHA, Obu-shi (JP)

(21) Appl. No.: 14/309,610

(22) Filed: Jun. 19, 2014

(30) Foreign Application Priority Data
Jun. 20, 2013 (JP) 2013-129517

(51) Int. Cl. G01N 27/22; E21B 49/08; G01N 27/02; G01V 3/00

(52) U.S. Cl. CPC G01N 27/221; G01V 3/00; E21B 49/08; G01N 27/02
USPC 324/324

(57) ABSTRACT

Provided herein is a sensor device that may include a first electrode pair, a second electrode pair, and a detector. The first electrode pair may be covered with a protective film. The second electrode pair may have at least a portion thereof exposed to liquid. The detector may be configured to detect a property of the liquid by using a value concerning an electrical conductivity of the liquid as determined by using the second electrode pair and a value concerning a capacitance of the first electrode pair.

### CROSS-REFERENCE TO RELATED APPLICATION

This application claims priority to Japanese Patent Application No. 2013-129517 filed on Jun. 20, 2013, the contents of which are hereby incorporated by reference into the present application.

### TECHNICAL FIELD

This specification discloses a sensor device that detects properties of a liquid by using an electrode pair.

### DESCRIPTION OF RELATED ART

Japanese Patent Application Publication No. 2005-351688 discloses a liquid level and liquid property sensor including a plurality of electrode pairs. Each of the plurality of electrode pairs is used with at least a portion thereof immersed in liquid.

### SUMMARY

An electrode pair that is immersed in liquid is easily corroded by the liquid. In this specification, a technology is provided that may properly detect the properties of liquid while inhibiting corrosion of an electrode pair.

A sensor device disclosed herein comprises: a first electrode pair covered with a protective film; a second electrode pair at least a portion of which is exposed to liquid; and a detector configured to detects a property of the liquid by using a value concerning an electrical conductivity of the liquid as determined by using the second electrode pair and a value concerning a capacitance of the first electrode pair.

the first electrode pair may be prevented from being exposed to the liquid by covering the first electrode pair with the protective film. As a result, the first electrode pair may he inhibited from corroding.

A dielectric constant of the liquid varies depending on the properties of the liquid, for example a concentration of a substance that is contained in the liquid, a temperature of the liquid, a degree of deterioration of the liquid, etc. Further, an electrical conductivity of the liquid varies depending on a ratio of substances that are contained in the liquid, the temperature of the liquid, the degree of deterioration of the liquid, etc. This property detecting device detects the properties of the liquid by using the electrical conductivity of the liquid and the dielectric constant of the liquid. According to this configuration, the properties of the liquid may be properly detected.

### BRIEF DESCRIPTION OF DRAWINGS

FIG. 1 shows a schematic configuration of a sensor device of a first embodiment FIG. 2 shows a sectional view taken along cross-section II-II of FIG. 1. FIG. 3 shows a schematic circuit diagram of a control device. FIG. 4 shows a sensor of a second embodiment. FIG. 5 shows a surface of a substrate of a third embodiment. FIG. 6 shows a back surface of the substrate of the third embodiment. FIG. 7 shows a sectional view taken along cross-section VII-VII of FIG. 5. FIG. 8 shows a sensor of a variation.

### DETAILED DESCRIPTION

Some of the features of the embodiment described herein will be listed. Note that the below-listed technical features are technical elements that are independent of one another, and brings technical usefulness solely or in various combinations.

(Feature 1) A second electrode pair may be arranged close to a first electrode pair.

In a state in which liquid is stored in a container, a liquid property may not be homogenized in the container. The foregoing configuration, in which the first electrode pair and the second electrode pair are arranged close to each other, a detection error caused by the property inhomogeneity of the liquid stored in the container may be inhibited.

(Feature 2) the first electrode pair and the second electrode pair may have their upper ends located at a same height.

According to this configuration, in a case where the liquid is not homogenized in the direction of the height of the container, the sensor device from making a detection error due to the inhomogeneity of the liquid stored in the container may be inhibited.

(Feature 3) the second electrode pair may have a portion that is exposed to the liquid, the portion having a surface made of a material having corrosion resistance.

According to this configuration, corrosion of the second electrode pair may be inhibited.

(Feature 4) the second electrode pair may have a portion that is exposed to the liquid, the portion being made of a material having corrosion resistance.

According to this configuration, the second electrode pair having the corrosion resistance may be easily prepared.

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved sensor devices, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### First Embodiment

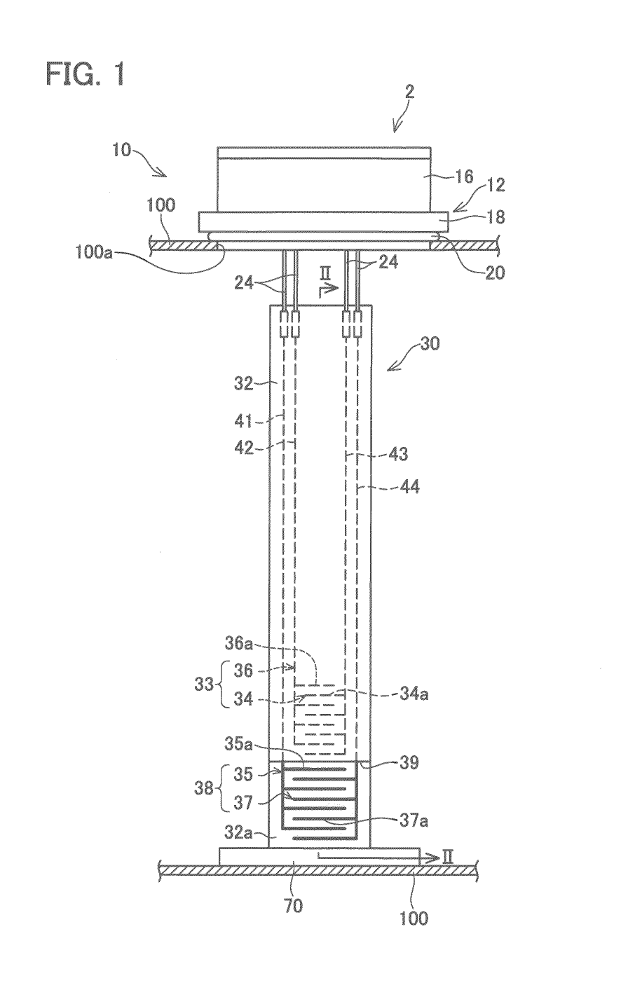

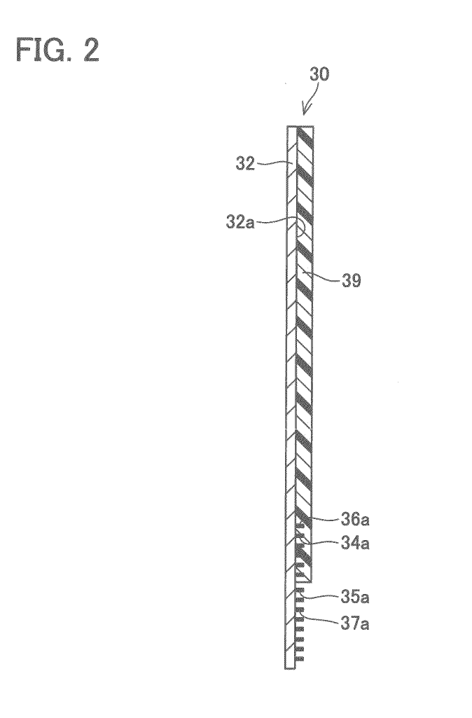

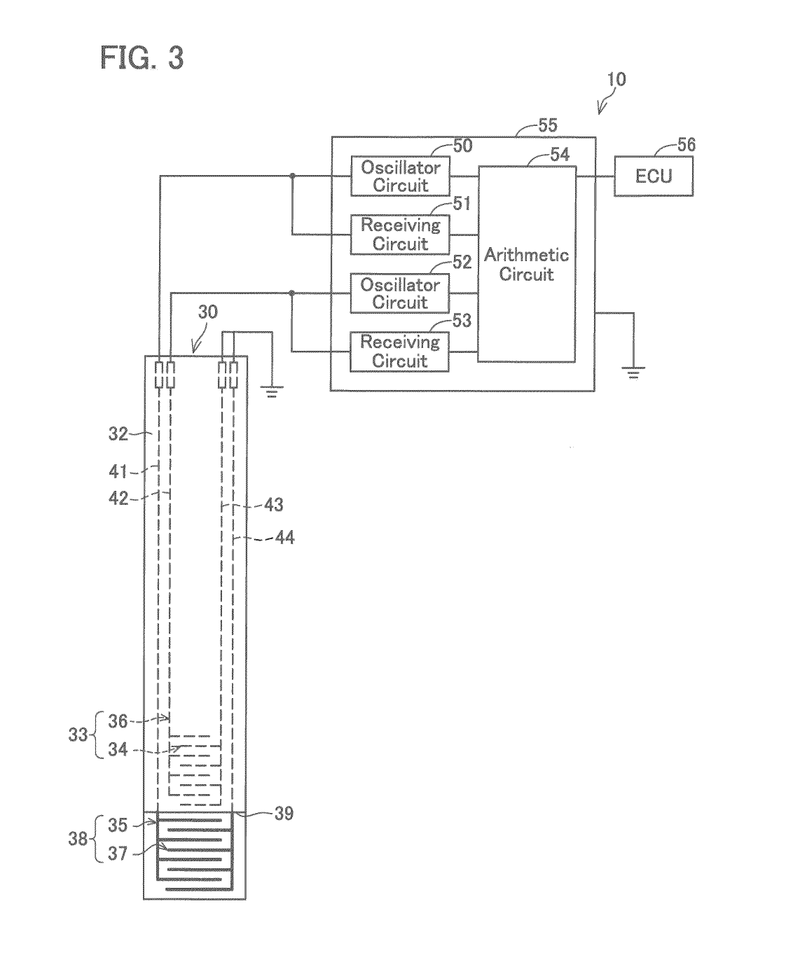

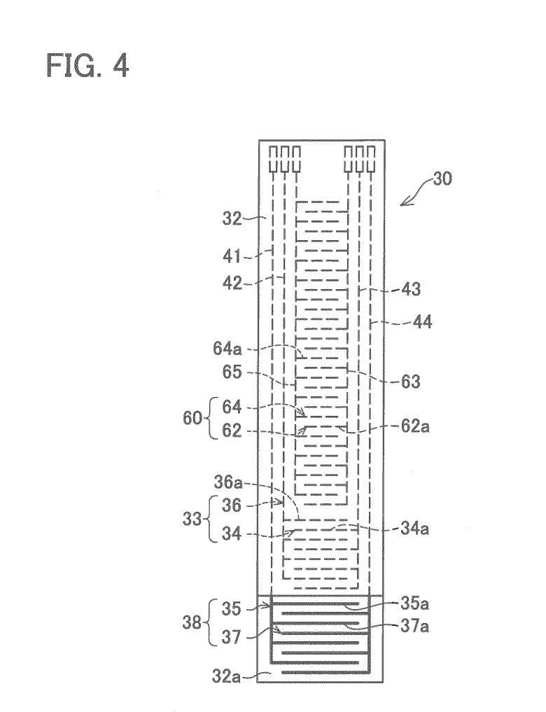

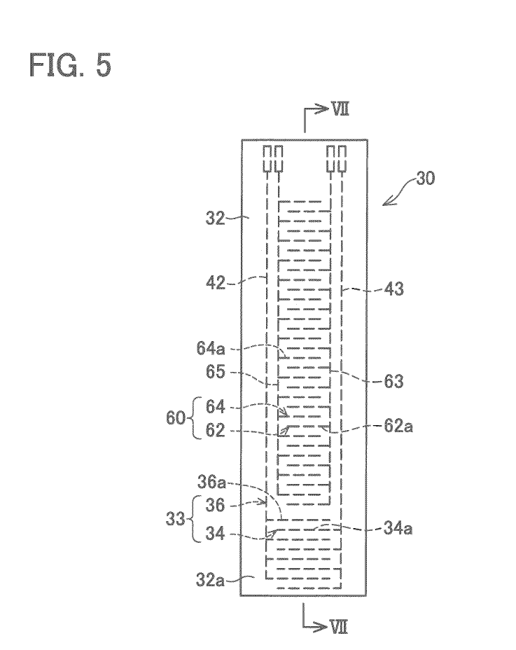

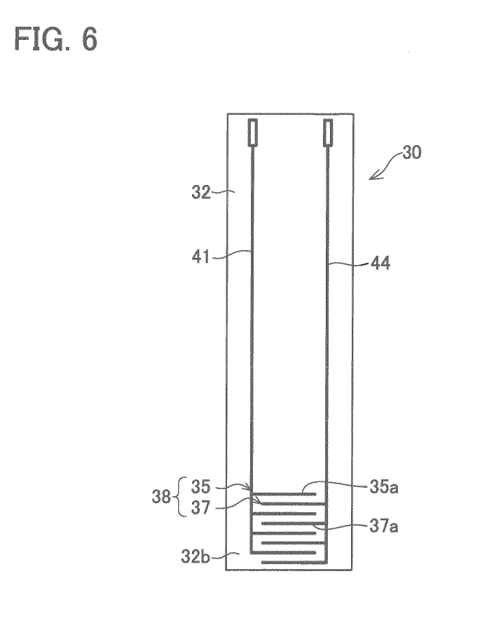

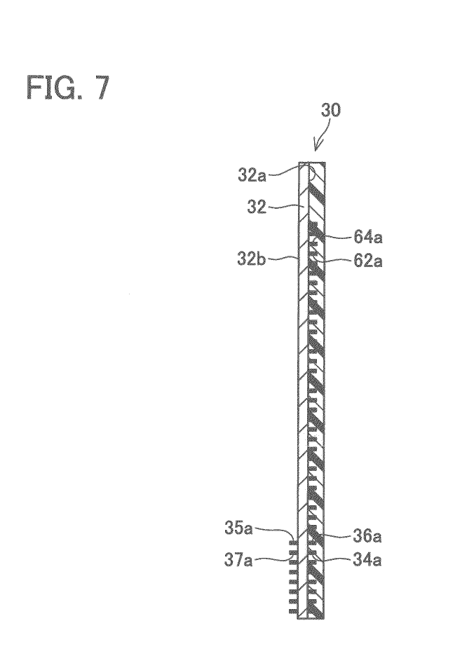

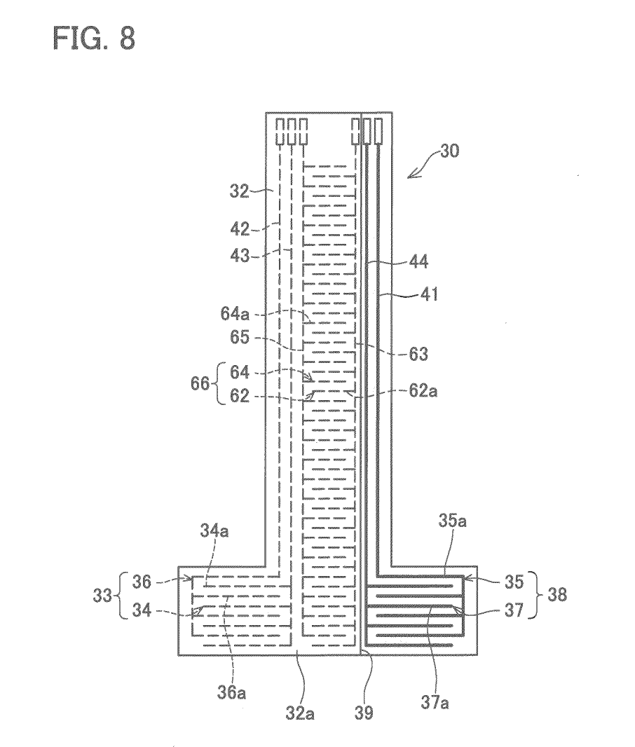

A sensor device 2 shown in FIG. 1 is mounted in a vehicle (e.g., an automobile). The vehicle runs on mixed fuel of gasoline and ethanol. The sensor device 2 is used for determining a concentration of ethanol in the fuel stored in a fuel tank 100. The sensor device 2 includes a control device 10 and a sensor 30.

The control device 10 is housed in a casing 12. The casing 12, attached to an opening 100a provided in an upper wall of the fuel tank 100, closes the opening 100a. The casing 12 includes a lid 18 and a housing case 16. The lid 18 is in the shape of a flat plate, an area of which is wider than an opening area of the opening 100a. The lid 18 has its outer edge portion in contact with the fuel tank 100 with a seal member 20 made of resin therebetween. The seal member 20 prevents the fuel from leaking through the opening 100a. Attached to an upper surface of the lid 18 is the housing case 16. The housing case 16 houses the control device 10. The housing case 16 is penetrated through by an external terminal (not illustrated). The external terminal is connected to an external power supply (for example, a battery) so that the control device 10 is supplied with electric power.

Penetrating through the lid 18 are the same number of lead wires 24 as the number of (i.e. four) longitudinal, electrodes of the sensor 30 described below. The lead wires 24 extend through the lid 18 into the fuel tank 100. The lead wires 24 electrically connect the control device 10 and the sensor 30.

The sensor 30 includes a substrate 32, two electrode pairs 33 and 38, and a protective film 39. The substrate 32 is a rectangular flat plate made of resin. The substrate 32 extends in the direction of the depth of the fuel tank 100. The electrode pairs 33 and 38 are arranged on one surface 32a of the substrate 32. The electrode pair 38 is placed at a lower end of the substrate 32, i.e. close to a bottom part of the fuel tank 100. The electrode pair 33 is arranged above the electrode pair 38.

The electrode pair 33 is made of a thin-film electrically-conducting material (for example, an alloy containing either copper or silver). The electrode pair 33 includes a reference electrode 34 and a signal electrode 36. The reference electrode 34 includes a plurality of (four in FIG. 1) electrode portions 34a and a longitudinal electrode 43 (it should be noted that, in FIG. 1 only one of the electrode portions 34a is marked with a reference sign). The longitudinal electrode 43 extends linearly from a position close to an upper end of the substrate 32 in a direction along the longer sides of the substrate 32 (i.e. in the direction of the depth of the fuel tank 100). It should be noted that the direction along the longer sides of the substrate 32 may be hereinafter referred to as “direction of the height of the sensor 30”. Connected to the longitudinal electrode 43 are one ends (right-side ends in FIG. 1) of the plurality of electrode portions 34a. The plurality of electrode portions 34a extends from the longitudinal electrode 43 leftward, i.e. toward a longitudinal electrode 42. The plurality of electrode portions 34a is electrically connected to one another via the longitudinal electrode 43. The plurality of electrode portions 34a is arranged parallel to one another and perpendicularly to the longitudinal electrode 43. The plurality of electrode portions 34a is arranged at regular intervals in the direction of the height of the sensor 30 (i.e. the direction in which the longitudinal electrode 43 extends).

The signal electrode 36 includes a plurality of (four in FIG. 1) electrode portions 36a and the longitudinal electrode 42 (it should be noted that in FIG. 1, only one of the electrode portions 36a is marked with a reference sign). The longitudinal electrode 42 extends linearly from a position close to the upper end of the substrate 32 in the direction along the longer sides of the substrate 32. Connected to the longitudinal electrode 42 are one ends (left-side ends in FIG. 1) of the plurality of electrode portions 36a. The plurality of electrode portions 36a extends from the longitudinal electrode 42 rightward, i.e. toward the longitudinal electrode 43. The plurality of electrode portions 36a is electrically connected to one another via the longitudinal electrode 42. The plurality of electrode portions 36a is arranged parallel to one another and perpendicularly to the longitudinal electrode 42. The plurality of electrode portions 36a is arranged at regular intervals along the direction of the height of the sensor 30. The electrode portions 34a and the electrode portions 36a are arranged alternately as seen in the direction of the height of the sensor 30.

The electrode pair 38 is made of a thin-film material (for example, carbon nanotubes, diamond-like carbon) having corrosion resistance against the mixed fuel. The electrode pair 38 includes a positive electrode 35 and a negative electrode 37. The positive electrode 35 includes a plurality of (four in FIG. 1) electrode portions 35a and a longitudinal electrode 41 (it should be noted that in FIG. 1 only one of the electrode portions 35a is marked with a reference sign). The longitudinal electrode 41 is arranged at the left side of the signal electrode 36. The longitudinal electrode 41 extends linearly from a position close to the upper end of the substrate 32 to a position close to the lower end of the substrate 32 in the direction along the longer sides of the substrate 32. Connected to the longitudinal electrode 41 below the electrode pair 33 are one ends (left-side ends in FIG. 1) of the plurality of electrode portions 35a. The plurality of electrode portions 35a extends from the longitudinal electrode 41 rightward, i.e. toward a longitudinal electrode 44. The plurality of electrode portions 35a is electrically connected to one another via the longitudinal electrode 41. The plurality of electrode portions 35a is arranged parallel to one another and perpendicularly to the longitudinal electrode 41. The plurality of electrode portions 35a is arranged at regular intervals along the direction of the height of the sensor 30.

The negative electrode 37 includes a plurality of (four in FIG. 1) electrode portions 37a and the longitudinal electrode 44 (it should be noted that in FIG. 1, only one of the electrode portions 37a is marked with a reference sign). The longitudinal electrode 44 is arranged at the right side of the reference electrode 34. The longitudinal electrode 44 extends linearly from a position close to the upper end of the substrate 32 to a position close to the lower end of the substrate 32 in the direction along the longer sides of the substrate 32. Connected to the longitudinal electrode 44 below the electrode pair 33 are one ends (right-side ends in FIG. 1) of the plurality of electrode portions 37a. The plurality of electrode portions 37a extends from the longitudinal electrode 44 leftward, i.e. toward the longitudinal electrode 41. The plurality of electrode portions 37a is electrically connected to one another via the longitudinal electrode 44. The plurality of electrode portions 37a is arranged parallel to one another and perpendicularly to the longitudinal electrode 44. The plurality of electrode portions 37a is arranged at regular intervals along the direction of the height of the sensor 30. The electrode portions 35a and the electrode portions 37a are arranged alternately as seen in the direction of the height of the sensor 30.

As shown in FIG. 2, the surface 32a of the substrate 32 is covered with the protective film 39. The protective film is made of a highly chemical-resistant and non-conducting material such as polyimide or polyphenylene sulfide resin, glass, or the like. The protective film 39 covers a region extending from an upper end of the surface 32a to a lower end of the electrode pair 33. The protective film 39 entirely covers the electrode pair 33. Further, the protective film 39 partially covers the longitudinal electrodes 41 and 44 of the electrode pair 38. The plurality of electrode portions 35a and 37a of the electrode pair 38 is not covered with the protective film 39 but is exposed to the fuel stored in the fuel tank 100.

As shown in FIG. 3, the control device 10 includes a substrate 55, oscillator circuits 50 and 52, receiving circuits 51 and 53, and an arithmetic circuit 54. Each of the circuits 50 to 54 is arranged on the substrate 55. The substrate 55 is grounded. Each of the circuits 50 to 54 is supplied with electric power by a power supply such as a battery connected to the substrate 55. Each of the oscillator circuits 50 and 52 generates either a signal (i.e. an AC voltage) or a pulse signal of a predetermined frequency (for example, 10 Hz to 3 MHz). The oscillator circuit 50 is connected to the positive electrode 35. The oscillator circuit 52 is connected to the signal electrode 36. The oscillator circuits 50 and 52 supply signals to the positive electrode 35 and the signal electrode 36 in sequence. It should be noted that the reference electrode 34 and the negative electrode 37 are grounded.

The receiving circuit 51 is connected between the oscillator circuit 50 and the positive electrode 35. The receiving circuit 51 detects the signal that is inputted from. the oscillator circuit 50 to the positive electrode 35. The receiving circuit 53 is connected between the oscillator circuit 52 and the signal electrode 36. The receiving circuit 53 detects the signal that is inputted from the oscillator circuit 52 to the signal electrode 36. The receiving circuits 51 and 53 output the detected signals to the arithmetic circuit 54.

The arithmetic circuit 54 is connected to each of the receiving circuits 51 and 53. Further, the arithmetic circuit 54 is connected to an ECU (the abbreviation of “Engine Control Unit”) 56. The arithmetic circuit 54 determines the concentration of ethanol in the fuel by using the signals inputted from the receiving circuits 51 and 53.

Specifically, the arithmetic circuit 54 calculates the electrical conductivity of the fuel by using the signal inputted from the receiving circuit 51. Further, the arithmetic circuit 54 calculates the capacitance of the electrode pair 33 by using the signal inputted from the receiving circuit 53. The electrode pair 33 is usually completely immersed in the fuel. For this reason, the capacitance of the electrode pair 33 is determined by the dielectric constant of the fuel. Since the dielectric constant of gasoline and the dielectric constant of ethanol are different, the dielectric constant of the fuel varies depending on the concentration of the ethanol in the fuel. Furthermore, the dielectric constant of the fuel varies depending on the temperature of the fuel, the degree of deterioration of the fuel, etc. The temperature of the fuel, the degree of deterioration of the fuel, etc. also exert influences on the electrical conductivity of the fuel. For this reason, the arithmetic circuit 54 corrects the capacitance of the electrode pair 33 by using the electrical conductivity of the fuel. From the corrected capacitance, influences other than those exerted by the ethanol concentration, i.e. the temperature of the fuel and the degree of deterioration of the fuel etc., are eliminated. The arithmetic circuit 54 stores in advance therein a first mathematical expression for correcting the capacitance of the electrode pair 33 by using the electrical conductivity of the fuel. The first mathematical expression is specified by an experiment or an analysis in advance. The arithmetic circuit 54 corrects the capacitance by using the first mathematical expression. it should be noted that in a variation, the arithmetic circuit 54 may store in advance therein a first database for correcting the capacitance of the electrode pair 33 by using the electrical conductivity of the fuel. The first database may be established in advance by an experiment or an analysis. The arithmetic circuit 54 may correct the capacitance by using the first database.

Next, the arithmetic circuit 54 calculates the dielectric constant of the fuel by using the capacitance thus corrected. The arithmetic circuit 54 further stores in advance therein a second mathematical expression representing a relationship between the dielectric constant of the fuel and the concentration of ethanol in the fuel. The second mathematical expression is specified by an experiment or an analysis in advance. The arithmetic circuit 54 calculates the concentration of ethanol in the fuel by using the second mathematical expression. It should be noted that, in a variation, the arithmetic circuit 54 may store in advance therein a second database representing a relationship between the dielectric constant of the fuel and the concentration of ethanol in the fuel. The second database may is established by an experiment or an analysis in advance. The arithmetic circuit 54 may determine the concentration of ethanol in the fuel by using the second database.

The arithmetic circuit 54 outputs the concentration of ethanol in the fuel thus determined to the ECU 56. The ECU 56 is a control device for controlling an engine (not illustrated) of an automobile. The ECU 56 controls each component (for example, an injector, a display section, etc.) by using the concentration of ethanol in the fuel as inputted from the arithmetic circuit 54.

### Effects of the Present Embodiment

In the present embodiment, the ethanol concentration of the fuel is detected by using the capacitance of the electrode pair 38 and the electrical conductivity of the fuel. This makes it possible to more properly determine the ethanol concentration of the fuel.

In the present embodiment, the electrode portions 35a and 37a of the electrode pair 38, which is made of a material having high resistance against corrosion by the fuel, are not covered with the protective film 39 but are exposed to the fuel stored in the fuel tank 100. In this configuration, the electrical conductivity (i.e. resistance) of the electrode pair 38, i.e. the dielectric constant of the fuel, is detected by detecting the value of an electric current passing through the electrode pair 38. This configuration makes it possible to properly detect the electrical conductivity of the fuel by using the electrode pair 38 without influence from the protective film 39.

Further, the electrode pair 33, which is made of a material having lower resistance against corrosion by the fuel than does the material of which the electrode pair 38 is made, is covered with the protective film 39. Cost can be saved in cases where the electrode pair 33 is made of the material having a relatively lower corrosion resistance, compared to a case where the electrode pair 33 is made of a material having a relatively higher corrosion resistance.

The ethanol concentration of the fuel stored in the fuel tank 100 may not be uniform. For example, a fuel of which an ethanol concentration is different from the ethanol concentration of the fuel stored in the fuel tank 100 may be fed into the fuel tank 100. In this case, the ethanol concentration of the fuel stored in the fuel tank 100 is not uniform immediately after fueling. In the present embodiment, the electrode pair 38 is arranged directly below the electrode pair 33. That is, the electrode pair 38 is arranged close to the electrode pair 33. For this reason, even if the ethanol concentration of the fuel stored in the fuel tank 100 is not uniform, each of the electrode pairs 33 and 38 can detect the properties of the fuel of which ethanol concentration is uniform.

### Second Embodiment

The second embodiment is described in terms of its differences from the first embodiment. A sensor device 2 of the second embodiment detects the liquid level of the fuel stored in the fuel tank 100 in addition to the ethanol concentration of the fuel. As shown in FIG. 4, an electrode pair 60 is arranged on a surface 32a of a substrate 32 in addition to electrode pairs 33 and 38.

The electrode pair 60 is located above the electrode pair 33 and between the two longitudinal electrodes 41 and 42. The electrode pair 60 is made of a thin-film electrically-conducting material (for example, an alloy containing either copper or silver). The electrode pair 60 is entirely covered with a protective film 39. The electrode pair 60 includes a reference electrode 62 and a signal electrode 64. The reference electrode 62 includes a plurality of (sixteen in FIG. 4) electrode portions 62a and a longitudinal electrode 63 (it should be noted that in FIG. 4 only one of the electrode portions 62a is marked with a reference sign). The longitudinal electrode 63 extends linearly from a position close to the upper end of the substrate 32 to a position close to the uppermost electrode portion 36a in the direction along the longer sides of the substrate 32. Connected to the longitudinal electrode 63 are one ends (right-side ends in FIG. 4) of the plurality of electrode portions 62a. The plurality of electrode portions 62a extends from the longitudinal electrode 63 leftward, i.e. toward a longitudinal electrode 65. The plurality of electrode portions 62a is electrically connected to one another via the longitudinal electrode 63. The plurality of electrode portions 62a is arranged parallel to one another and perpendicularly to the longitudinal electrode 63. The plurality of electrode portions 62a is arranged at regular intervals along the direction of the height of the sensor 30.

The signal electrode 64 includes a plurality of (sixteen in FIG. 4) electrode portions 64a and a longitudinal electrode 65 (It should be noted that in FIG. 4 only one of the electrode portions 64a is marked with a reference sign). The longitudinal electrode 65 is arranged in a similar manner to the longitudinal electrode 63. Connected to the longitudinal electrode 65 are one ends (left-side ends in FIG. 4) of the plurality of electrode portions 64a. The plurality of electrode portions 64a extends from the longitudinal electrode 65 toward the longitudinal electrode 63. The plurality of electrode portions 64a is electrically connected to one another via the longitudinal electrode 65. The plurality of electrode portions 64a is arranged parallel to one another and perpendicularly to the longitudinal electrode 65. The plurality of electrode portions 64a is arranged at regular intervals along the direction of the height of the sensor 30. The electrode portions 62a and the electrode portions 64a are arranged alternately as seen in the direction of the height of the sensor 30.

In the electrode pair 60, a length of a portion immersed in the fuel (i.e., exposed to the fuel) and a length of a portion exposed to gas in the fuel tank 100 change in accordance with a change in a liquid level of the fuel stored in the fuel tank 100. This results in change in dielectric constant of a region surrounding the electrode pair 60. Because of this relationship, the capacitance of the electrode pair 60 varies in a correlated way depending on the liquid level of the fuel. Further, the capacitance of the electrode pair 60 varies depending on the dielectric constant of the fuel.

A control device 10 includes an oscillation circuit (riot illustrated), connected to the signal. electrode 64, which supplies a signal to the signal electrode 64. It should be noted that the reference electrode 62 is grounded. The control device 10 further includes a receiving circuit (not illustrated) connected between the oscillator circuit 50 and the signal electrode 64. The arithmetic circuit 54 obtains, from the receiving circuit, a signal that is inputted to the signal electrode 64. The arithmetic circuit 54 calculates the capacitance of the electrode pair 60 by using the signal thus inputted. Next, the arithmetic circuit 54 determines the liquid level of the fuel by using the capacitance of the electrode pair 60 and the dielectric constant of the fuel.

This configuration makes it possible to inhibit the electrode pair 60 from being corroded by the fuel. Further, since the liquid level of the fuel is determined by using the capacitance of the electrode pair 60 and the dielectric constant of the fuel, the liquid level of the fuel can be properly determined.

### Third Embodiment

The third embodiment is described in terms of its differences from the second embodiment. As shown in FIG. 6, an electrode pair 38 is arranged on a back surface 32b of the substrate 32. Further, as shown in FIG. 5, the electrode pair 33 is arranged close to the lower end of the surface 32a. As shown in FIG. 7, the protective film 39 entirely covers the surface 32a. It should be noted that there is no protective film placed on the back surface 32b, and the electrode pair 38 is entirely exposed to the fuel.

This configuration makes it possible to arrange the electrode pair 33 and the electrode pair 38 at the same height or, in particular, arrange the electrode portions 34a to 37a in a range of the same height. Immediately after fueling, the fuel stored in the fuel tank 100 may be distributed inhomogeneously in the direction of the height of the fuel tank. This configuration allows the electrode pair 33 and the electrode pair 38 to detect fuel having a uniform property even when the fuel stored in the fuel tank 100 is distributed inhomogeneously in the direction of the height of the fuel tank.

Further, the electrode pair 33 can be arranged close to the lower end of the substrate 32. This configuration makes it possible to inhibit the electrode pair 33 from being exposed on the surface of the fuel due to depletion of the fuel.

### Variation

(1) In the embodiment described above, the sensor 30 may include one or more electrode pairs other than the three electrode pairs 33, 38, and 60. For example, in a case where the surface of the fuel is below an upper end of the electrode pair 38, the control device 10 may use an electrode pair other than the three electrode pairs 33, 38, and 60 to calculate a capacitance that is correlated with the dielectric constant and temperature of the fuel but is not correlated with the liquid level of the fuel.

(2) The embodiment described above is not intended to limit a positional relationship among the electrode pairs 33, 38, and 60. As shown in FIG. 8, the electrode pairs 33 and 38 may be located at the sides of the electrode pair 60, respectively. In this case, the electrode pairs 33 and 38 may be at the same height. Further, the protective film 39 may cover the electrode pairs 33 and 60 other than the electrode pair 38.

(3) The sensor device disclosed in this specification is not limited to the sensor device 2 that determines the properties of a fuel. For example, the sensor device may determine the properties of engine oil in an engine (for example, the temperature, liquid level, dielectric constant, etc. of the engine oil). Further, the sensor device 2 may determine the degree of deterioration of a liquid by using, for example, the dielectric constant of the liquid, other than the temperature, ethanol concentration, and liquid level of the fuel. In this variation, the degree of deterioration of the liquid is an example of the “properties of the liquid”.

(4) The circuit configuration of the control device 10 is not limited to the configuration shown in FIG. 3. For example, the control device 10 may include only one oscillator circuit. In this case, the control device 10 may include a switch that changes between a state in which to supply a signal to the positive electrode 35 and a state in which to supply a signal to the signal electrode 36. Similarly, the control device 10 may include one receiving circuit and a switch that changes between a state in which to connect the receiving circuit between the oscillator circuit and the positive electrode 35 and a state in which to connect the receiving circuit between the oscillator circuit and the signal electrode 36. Further, the receiving circuits 51 and 53 may each be connected to the negative electrode 37 and the reference electrode 34 separately.

What is claimed is:

1. A sensor device comprising:
a first electrode pair covered with a protective film;
a second electrode pair at least a portion of which is exposed to liquid; and
a detector configured to detects a property of the liquid by using a value concerning an electrical conductivity of the liquid as determined by using the second electrode pair and a value concerning a capacitance of the first electrode pair.

2. The sensor device as set forth in claim 1, wherein the second electrode pair is arranged close to the first electrode pair.

3. The sensor device as set forth in claim 1, wherein the first electrode pair and the second electrode pair have their upper ends located at a same height.

4. The sensor device as set forth in claim 1, wherein the second electrode pair has a portion that is exposed to the liquid, the portion having a surface made of a material having corrosion resistance.

5. The sensor device as set forth in claim 1, wherein the second electrode pair has a portion that is exposed to the liquid, the portion being made of a material having corrosion resistance.

6. The sensor device as set forth in claim 1, further comprising,
a substrate on which the first electrode pair is arranged.

7. The sensor device as set forth in claim 6, wherein the second electrode pair is arranged on the substrate.

8. The sensor device as set forth in claim 7, wherein
the first electrode pair is arranged on one surface of the substrate, and
the second electrode pair is arranged on another surface of the substrate.
